(19) United States
(12) Patent Application Publication
(10) Pub. No.: US 2018/0150079 A1
(43) Pub. Date: May 31, 2018

(54) DRIVING SUPPORT APPARATUS AND DRIVING SUPPORT METHOD

(71) Applicant: MITSUBISHI ELECTRIC CORPORATION, Tokyo (JP)

(72) Inventor: Naoki ISOZAKI, Tokyo (JP)

(73) Assignee: MITSUBISHI ELECTRIC CORPORATION, Tokyo (JP)

(21) Appl. No.: 15/576,581

(22) PCT Filed: Jun. 12, 2015
(86) PCT No.: PCT/JP2015/066958

§ 371 Date: Nov. 22, 2017

(51) Int. Cl. G05D 1/02; G01C 21/36; G08G 1/09

(52) U.S. Cl. CPC G05D 1/0217; G05D 1/0276; G08G 1/09; G01C 21/3691

(57) ABSTRACT

It is an object of the present invention to provide a driving support apparatus and a driving support method capable of performing an appropriate driving support. The driving support apparatus according to the present invention includes a processor to execute a program; and a memory to store the program which, when executed by the processor, performs processes of: acquiring information including an environmental information which is information indicating an environment of a road in a case where each of a plurality of vehicles travels, a travel information which is information regarding a traveling of each of the vehicles, and a vehicle information which is information regarding each of the vehicles, accumulating the acquired information, calculating a recommendation driving method based on the accumulated information and providing the vehicle which is capable of performing an automatic driving in the plurality of vehicles with a notice of the calculated recommendation driving method.

### TECHNICAL FIELD

The present invention relates to a driving support apparatus and a driving support method of recommending a driving method at a time of an automatic driving to a vehicle which is capable of performing an automatic driving.

### BACKGROUND ART

Conventionally disclosed is a technique of calculating a fuel saving evaluation parameter based on a travel history data of a vehicle to provide a user with an advice of a fuel saving driving (for example, refer to Patent Document 1). Also disclosed is a technique of proposing an improvement idea, in view of a fuel consumption, to a driver of a vehicle and an administrator of the vehicle based on an operation data obtained from the vehicle (for example, refer to Patent Document 2).

### PRIOR ART DOCUMENTS

### Patent Documents

Patent Document 1: Japanese Patent Application Laid-Open No. 2011-253239

Patent Document 2: Japanese Patent Application Laid-Open No. 2003-16572

### SUMMARY

### Problem to be Solved by the Invention

A consumption efficiency of a vehicle and an endurance time of components provided in the vehicle significantly differ depending on a driving technique of the vehicle and a condition of a road (that is to say, an environment in driving the vehicle and a state of the vehicle). It is considered that there is a driving method of enhancing a fuel efficiency or a driving method of enhancing endurance of the component for each type of the road (for example, an express highway, a general road, a road including many slopes, and a road including many curves, for example).

However, Patent Documents 1 and 2 do not provide an advice (proposal) in consideration of the environment in driving the vehicle and the state of the vehicle. Patent Documents 1 and 2 do not also consider the endurance of the components provided in the vehicle. Furthermore, Patent Documents 1 and 2 do not consider a driving support for the vehicle performing an automatic driving. As described above, an appropriate driving support has not necessarily been performed conventionally.

The present invention is to solve the problems described above, and it is an object of the present invention to provide a driving support apparatus and a driving support method capable of performing an appropriate driving support.

### Means to Solve the Problem

To solve the problem described above, a driving support apparatus according to the present invention includes: an information acquiring unit acquiring information including an environmental information which is information indicating an environment of a road in a case where each of a plurality of vehicles travels, a travel information which is information regarding a traveling of each of the vehicles, and a vehicle information which is information regarding each of the vehicles; an information accumulating unit accumulating the information acquired by the information acquiring unit; a recommendation driving method calculating unit calculating a recommendation driving method which is a driving method recommended at a time of traveling along the road based on the information accumulated in the information accumulating unit; and a notification unit providing the vehicle which is capable of performing an automatic driving in the plurality of vehicles with a notice of the recommendation driving method calculated by the recommendation driving method calculating unit.

A driving support method according to the present invention (a) acquiring information including an environmental information which is information indicating an environment of a road in a case where each of a plurality of vehicles travels, a travel information which is information regarding the traveling of each vehicle, and a vehicle information which is information regarding each vehicle, (b) accumulating the acquired information, (c) calculating a recommendation driving method which is a driving method recommended at a time of traveling along the road based on the accumulated information, and (d) providing the vehicle which is capable of performing an automatic driving in the plurality of vehicles with a notice of the calculated recommendation driving method.

### Effects of the Invention

According to the present invention, the driving support apparatus includes: an information acquiring unit acquiring information including an environmental information which is information indicating an environment of a road in a case where each of a plurality of vehicles travels, a travel information which is information regarding a traveling of each of the vehicles, and a vehicle information which is information regarding each of the vehicles; an information accumulating unit accumulating the information acquired by the information acquiring unit; a recommendation driving method calculating unit calculating a recommendation driving method which is a driving method recommended at a time of traveling along the road based on the information accumulated in the information accumulating unit; and a notification unit providing the vehicle which is capable of performing an automatic driving in the plurality of vehicles with a notice of the recommendation driving method calculated by the recommendation driving method calculating unit, thereby enabling an appropriate driving support.

A driving support method (a) acquiring information including an environmental information which is information indicating an environment of a road in a case where each of a plurality of vehicles travels, a travel information which is information regarding the traveling of each vehicle, and a vehicle information which is information regarding each vehicle, (b) accumulating the acquired information, (c) calculating a recommendation driving method which is a driving method recommended at a time of traveling along the road based on the accumulated information, and (d) providing the vehicle which is capable of performing an automatic driving in the plurality of vehicles with a notice of the calculated recommendation driving method, thereby enabling an appropriate driving support.

These and other objects, features, aspects and advantages of the present invention will become more apparent from the following detailed description of the present invention when taken in conjunction with the accompanying drawings.

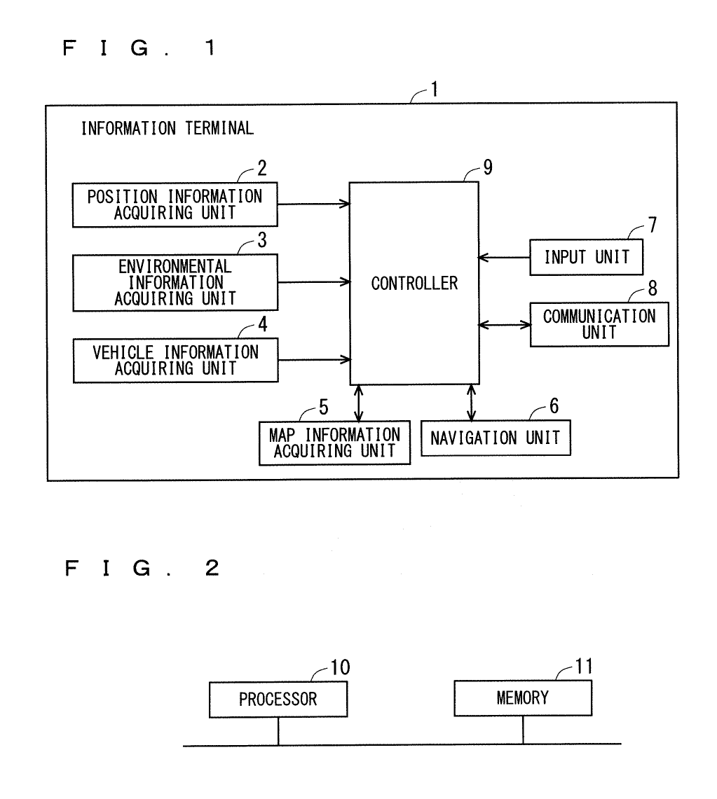

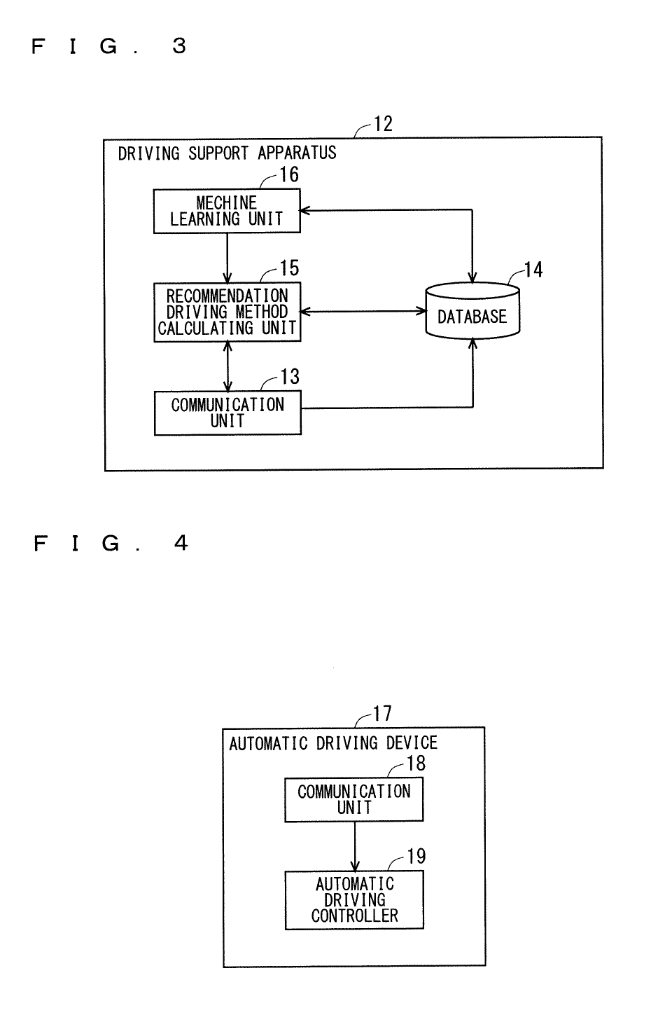

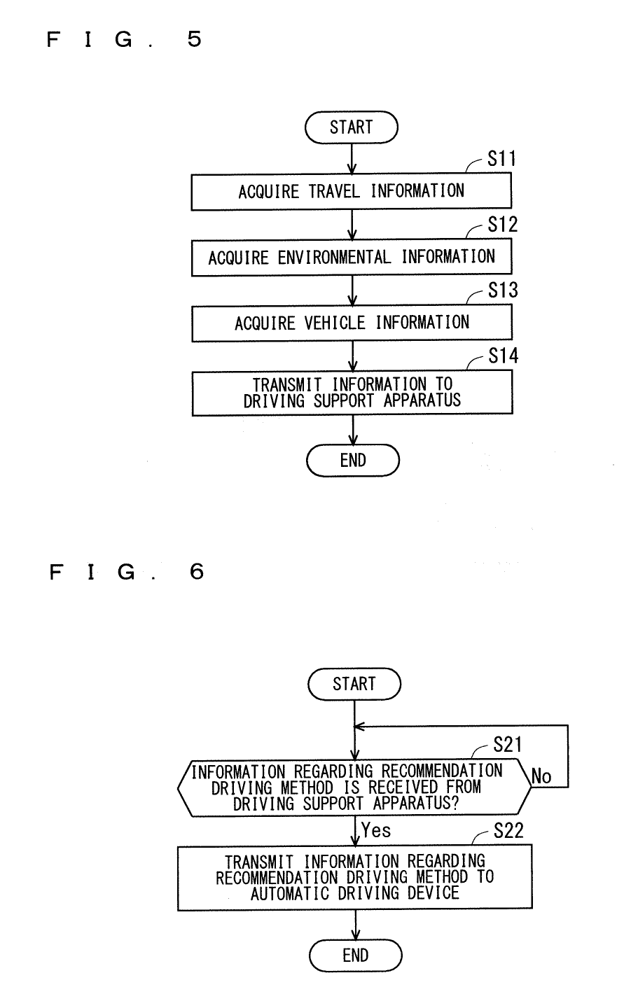

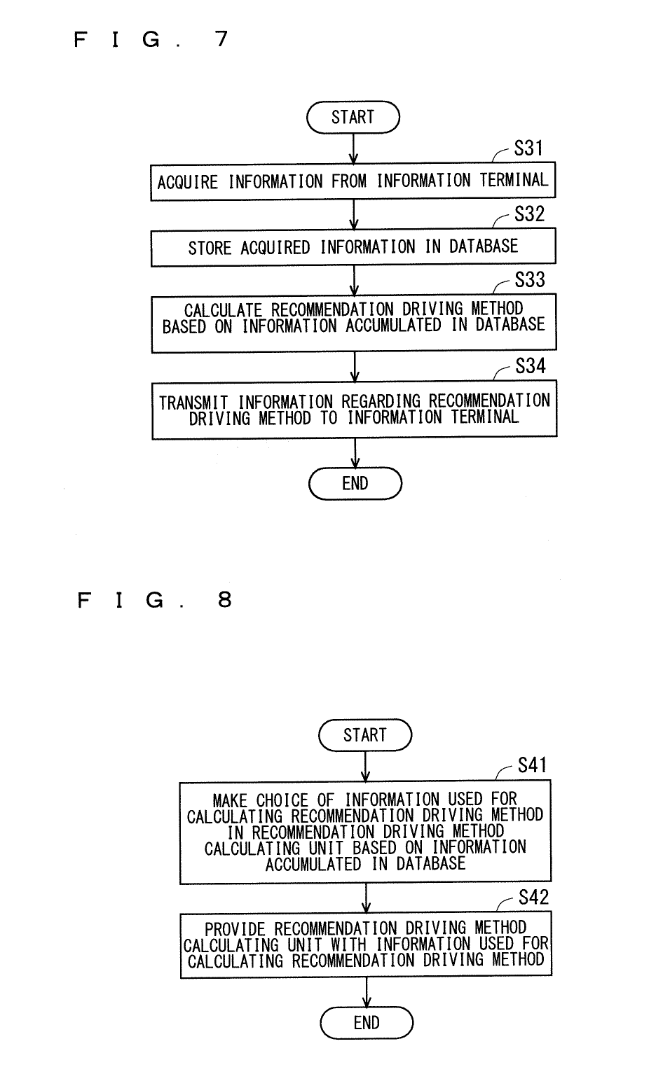

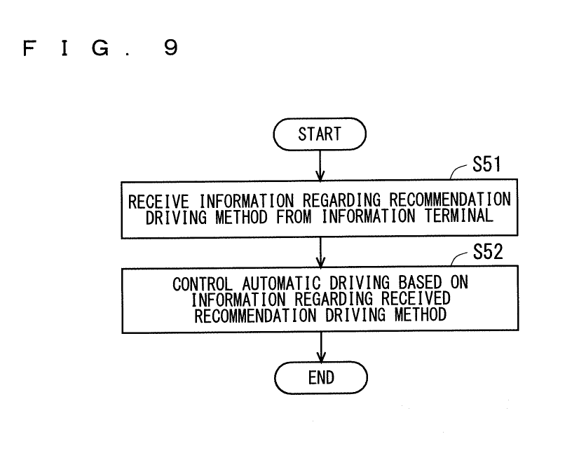

### BRIEF DESCRIPTION OF DRAWINGS

[FIG. 1] A block diagram illustrating an example of a configuration of an information terminal according to an embodiment of the present invention.

[FIG. 2] A block diagram illustrating an example of a hardware configuration of the information terminal according to the embodiment of the present invention.

[FIG. 3] A block diagram illustrating an example of a configuration of a driving support apparatus according to the embodiment of the present invention.

[FIG. 4] A block diagram illustrating an example of a configuration of an automatic driving device according to the embodiment of the present invention.

[FIG. 5] A flow chart illustrating an example of an operation of the information terminal according to the embodiment of the present invention.

[FIG. 6] A flow chart illustrating an example of the operation of the information terminal according to the embodiment of the present invention.

[FIG. 7] A flow chart illustrating an example of the operation of the driving support apparatus according to the embodiment of the present invention.

[FIG. 8] A flow chart illustrating an example of the operation of the driving support apparatus according to the embodiment of the present invention.

[FIG. 9] A flow chart illustrating an example of the operation of the automatic driving device according to the embodiment of the present invention.

### DESCRIPTION OF EMBODIMENT(S)

The embodiment of the present invention is described hereinafter based on the drawings.

### Embodiment

<Configuration>

Firstly, a configuration of an apparatus performing a driving support of a vehicle according to the embodiment of the present invention is described. In the present embodiment, a driving support apparatus 12 (refer to FIG. 3) calculates a recommendation driving method based on information acquired by an information terminal 1 (refer to FIG. 1). Then, an automatic driving device 17 (refer to FIG. 4) controls an automatic driving of the vehicle based on the recommendation driving method calculated by the driving support apparatus 12. The information terminal 1 and the driving support apparatus 12 are mounted on the vehicle. The vehicle can perform the automatic driving under control of the automatic driving device 17. The present embodiment describes a case of supporting (controlling) the automatic driving of the vehicle using the automatic driving device 17.

FIG. 1 is a block diagram illustrating an example of a configuration of the information terminal 1.

As illustrated in FIG. 1, the information terminal 1 includes a position information acquiring unit 2, an environmental information acquiring unit 3, a vehicle information acquiring unit 4, a map information acquiring unit 5, a navigation unit 6, an input unit 7, a communication unit 8, and a controller 9.

The position information acquiring unit 2 acquires information of a current position of the vehicle. Specifically, the position information acquiring unit 2 acquires information of a current position using a global positioning system (GPS), for example.

The environmental information acquiring unit 3 acquires an environmental information which is information indicating an environment of a road along which the vehicle travels. The environmental information includes, for example, a weather information which is information indicating weather when the vehicle travels along the road (a clear weather, a rainy weather, a humidity, a temperature, and an accumulated snow, for example), information of a season, a road surface information which is information indicating a state of a road surface of the road (a convex-concave state of the road surface and a deterioration state of the road surface, for example), information of a period of time when the vehicle has passed through the road, and information of a date when the vehicle has passed through the road, for example.

The weather information may be acquired from outside via Internet, but is not limited thereto. For example, a state of the weather around the vehicle may be determined using a camera provided in the vehicle, and the information of the temperature and humidity may be acquired by a sensor provided in the vehicle. The information of the season may be determined based on information of a calendar, for example. The information of the calendar may be acquired from outside, or may be stored in a storage not shown in the information terminal 1. The convex-concave state and deterioration state of the road surface are detected by a sensor provided in the vehicle, for example.

The vehicle information acquiring unit 4 acquires a vehicle information which is information regarding the vehicle. The vehicle information includes a type of vehicle, a repairing state of a vehicle, a rotation radius of a vehicle, a remaining fuel (a remaining amount of gasoline in a case where a vehicle is a gasoline vehicle), a battery charge remaining (a remaining amount of power in a case where a vehicle is an electrical vehicle), information regarding a component replacement of a vehicle, a total travel distance of a vehicle, a total lighting time of a head light, a total number of opening and closing a door, a total operating time and number of operating a wiper, an operation information of a brake, an operation information of an accelerator, an operation information of a handle, a speed information, a total number of engine rotations (in a case where a vehicle is a gasoline vehicle), and a total number of motor rotations (in a case where a vehicle is an electrical vehicle or a hybrid vehicle), for example.

The components include the head light, the door, the wiper, the brake, the accelerator, and the handle described above. The repairing state of the vehicle is a history information indicating when and which component has been repaired. The information regarding the component replacement of the vehicle is information indicating that a user has replaced the component by design even when the component is not broken. The operation information of the brake or accelerator includes the total number of operating the brake or accelerator. Applicable to the type of vehicle are a type such as a truck, a mini-vehicle, or the like, a type in accordance with a vehicle name, or a type such as a gasoline vehicle, a hybrid vehicle, an electrical vehicle, or the like. A storage not shown in the information terminal 1 stores the information of the type of vehicle, the repairing state of the vehicle, the rotation radius of the vehicle, the information regarding the component replacement of the vehicle, the total travel distance of the vehicle, the total lighting time of the head light, the total number of operating the brake, and the total number of operating the accelerator.

The map information acquiring unit 5 is made up of a storage such as a hard disk drive (HDD) or a semiconductor memory, for example, to acquire and store the map information. The map information acquiring unit 5 may externally acquire the map information. For example, the map information acquiring unit 5 may download and acquire the map information from an external server, for example, via a communication network, or may also read out and acquire the map information from a storage medium such as a memory.

Based on the map information stored in the map information acquiring unit 5, a current position acquired by the position information acquiring unit 2, and a destination set by the user via the input unit 7, the navigation unit 6 calculates and guides a route from the current position to the destination.

The input unit 7 is made up of a touch panel, software key, or a hardware key, for example, to receive the operation performed by the user.

The communication unit 8 communicates with the driving support apparatus 12 and the automatic driving device 17. Specifically, the communication unit 8 communicates with the driving support apparatus 12 via a communication network such as Internet, for example. The communication unit 8 communicates with the automatic driving device 17 via an in-vehicle LAN, for example. The controller 9 controls the whole information terminal 1.

FIG. 2 is a diagram illustrating an example of a hardware configuration of the information terminal 1.

Each function of the position information acquiring unit 2, the environmental information acquiring unit 3, the vehicle information acquiring unit 4, the navigation unit 6, the input unit 7, the communication unit 8, and the controller 9 in the information terminal 1 is achieved by a processing circuit. That is to say, the information terminal 1 includes the processing circuit to acquire the position information, the environmental information, and the vehicle information, search the route, receive the input, communicate with the driving support apparatus 12 and the automatic driving device 17, and control the whole information terminal 1. The processing circuit is a processor 10 (also referred to as a central processing unit, a processing device, an arithmetic device, a microprocessor, a microcomputer, or a digital signal processor (DSP)) for executing a program stored in a memory 11.

Each function of the position information acquiring unit 2, the environmental information acquiring unit 3, the vehicle information acquiring unit 4, the navigation unit 6, the input unit 7, the communication unit 8, and the controller 9 in the information terminal 1 is achieved by a software, a firmware, or a combination of a software and firmware. The software or the firmware is described as a program, and is stored in the memory 11. The processing circuit reads out and executes the program stored in the memory 11, thereby achieving the functions of each part. That is to say, the information terminal 1 includes the memory 11 to store the program to resultingly execute a step of acquiring the position information, a step of acquiring the environmental information, a step of acquiring the vehicle information, a step of searching the route, a step of receive the input, a step of communicating with the driving support apparatus 12 and the automatic driving device 17, and a step of controlling the whole information terminal 1. This program is also deemed to cause a computer to execute a procedure or a method of the position information acquiring unit 2, the environmental information acquiring unit 3, the vehicle information acquiring unit 4, the navigation unit 6, the input unit 7, the communication unit 8, and the controller 9. Herein, a non-volatile or volatile semiconductor memory such as a Random Access Memory (RAM), a Read Only Memory (ROM), a flash memory, an Erasable Programmable Read Only Memory (EPROM), or an Electrically Erasable Programmable Read Only Memory (EEPROM), a magnetic disk, a flexible disk, an optical disk, a compact disk, a mini disk, or a Digital Versatile Disk (DVD), for example, falls under the memory.

FIG. 3 is a block diagram illustrating an example of a configuration of the driving support apparatus 12.

As illustrated in FIG. 3, the driving support apparatus 12 includes a communication unit 13, a database 14, a recommendation driving method calculating unit 15, and a machine learning unit 16.

The communication unit 13 (the information acquiring unit) communicates with the information terminal 1. The database 14 (the information accumulating unit) is made up of a storage device such as hard disk or a semiconductor memory, for example, to accumulate the information received from the information terminal 1 via the communication unit 13.

The recommendation driving method calculating unit 15 calculates a recommendation driving method, which is a driving method recommended when the vehicle travels along the road, based on the information accumulated in the database 14. Examples of the recommendation driving method include a driving method of enhancing a fuel efficiency or a driving method of enhancing an endurance time of the component provided in the vehicle.

The machine learning unit 16 (the learning unit) selects, by performing the machine learning, the information used when the recommendation driving method calculating unit 15 calculates the recommendation driving method.

The processing circuit achieves each function of the communication unit 13, the recommendation driving method calculating unit 15, and the machine learning unit 16 in the driving support apparatus 12. That is to say, the driving support apparatus 12 includes the processing circuit for communicating with the information terminal 1, calculating the recommendation driving method, and selecting the information used to calculate the recommendation driving method. The processing circuit is the processor 10 (also referred to as the central processing unit, the processing device, the arithmetic device, the microprocessor, the microcomputer, or the DSP) for executing the program stored in the memory 11 (refer to FIG. 2).

Each function of the communication unit 13, the recommendation driving method calculating unit 15, and the machine learning unit 16 in the driving support apparatus 12 is achieved by a software, a firmware, or a combination of a software and firmware. The software or the firmware is described as a program, and is stored in the memory 11 (refer to FIG. 2). The processing circuit reads out and executes the program stored in the memory 11, thereby achieving the functions of each part. That is to say, the driving support apparatus 12 includes the memory 11 to store the program to resultingly execute a step of communicating with the information terminal 1, a step of calculating the recommendation driving method, and a step of selecting the information used to calculate the recommendation driving method. This program is also deemed to cause a computer to execute a procedure or a method of the communication unit 13, the recommendation driving method calculating unit 15, and the machine learning unit 16. Herein, a non-volatile or volatile semiconductor memory such as a RAM, a ROM, a flash memory, an EPROM, or an EEPROM, a magnetic disk, a flexible disk, an optical disk, a compact disk, a mini disk, or a DVD, for example, falls under the memory.

FIG. 4 is a block diagram illustrating an example of a configuration of the automatic driving device 17.

As illustrated in FIG. 4, the automatic driving device 17 includes a communication unit 18 and an automatic driving controller 19.

The communication unit 18 communicates with the information terminal 1. The automatic driving controller 19 controls the automatic driving of the vehicle based on the recommendation driving method received from the information terminal 1 via the communication unit 18.

The processing circuit achieves each function of the communication unit 18 and the automatic driving controller 19 in the automatic driving device 17. That is to say, the automatic driving device 17 includes the processing circuit for communicating with the information terminal 1 and controlling the automatic driving. The processing circuit is the processor 10 (also referred to as the central processing unit, the processing device, the arithmetic device, the microprocessor, the microcomputer, or the DSP) for executing the program stored in the memory 11 (refer to FIG. 2).

Each function of the communication unit 18 and the automatic driving controller 19 in the automatic driving device 17 is achieved by a software, a firmware, or a combination of a software and firmware. The software or the firmware is described as a program, and is stored in the memory 11 (refer to FIG. 2). The processing circuit reads out and executes the program stored in the memory 11, thereby achieving the functions of each part. That is to say, the automatic driving device 17 includes the memory 11 to store the program to resultingly execute a step of communicating with the information terminal 1 and a step of controlling the automatic driving. This program is also deemed to cause a computer to execute a procedure or a method of the communication unit 18 and the automatic driving controller 19. Herein, a non-volatile or volatile semiconductor memory such as a RAM, a ROM, a flash memory, an EPROM, or an EEPROM, a magnetic disk, a flexible disk, an optical disk, a compact disk, a mini disk, or a DVD, for example, falls under the memory.

<Operation>

Next, each operation of the information terminal 1, the driving support apparatus 12, and the automatic driving device 17 is described.

FIG. 5 is a flow chart illustrating an example of the operation of the information terminal 1, and illustrates an operation of transmitting the information to the driving support apparatus 12.

In Step S11, the controller 9 acquires a travel information which is information regarding the traveling of the vehicle. Specifically, the controller 9 acquires the position information of the road along which the vehicle is currently traveling as the information regarding the traveling based on the current position information acquired by the position information acquiring unit 2 and the map information acquired by the map information acquiring unit 5. Accordingly, the controller 9 can specify which road and which point the vehicle is traveling in.

The controller 9 acquires the information of a condition of searching the route, which is set by the user via the input unit 7 to be used in the navigation unit 6, from the navigation unit 6 as the information regarding the traveling.

In Step S12, the environmental information acquiring unit 3 acquires the environmental information. Subsequently, the environmental information acquiring unit 3 outputs the acquired environmental information to the controller 9.

In Step S13, the vehicle information acquiring unit 4 acquires the vehicle information. Subsequently, the vehicle information acquiring unit 4 outputs the acquired vehicle information to the controller 9.

In Step S14, the controller 9 transmits the travel information, the environmental information, and the vehicle information to the driving support apparatus 12 via the communication unit 8. At this time, the controller 9 may transmit only the information selected by the user via the input unit 7 to the driving support apparatus 12. The information transmitted to the driving support apparatus 12 includes at least the position information. The information terminal 1 transmits the information to the driving support apparatus 12 at a fixed time interval.

FIG. 6 is a flow chart illustrating an example of the operation of the information terminal 1, and illustrates an operation of receiving the information regarding the recommendation driving method from the driving support apparatus 12.

In Step S21, the controller 9 determines whether or not the information regarding the recommendation driving method is received from the driving support apparatus 12 via the communication unit 8. When the information regarding the recommendation driving method is received from the driving support apparatus 12, the processing proceeds to Step S22. In the meanwhile, when the information regarding the recommendation driving method is not received from the driving support apparatus 12, the processing of Step S21 is repeated.

In Step S22, the controller 9 transmits the information regarding the recommendation driving method received from the driving support apparatus 12 to the automatic driving device 17.

FIG. 7 is a flow chart illustrating an example of the operation of the driving support apparatus 12, and illustrates an operation of transmitting the information regarding the recommendation driving method to the information terminal 1.

In Step S31, the communication unit 13 receives the information from the information terminal 1.

In Step S32, the communication unit 13 stores the information received from the information terminal 1 in the database 14. At this time, the database 14 stores the information associated with the position information. That is to say, the information received from the information terminal 1, which is mounted on each vehicle, is associated with the position information and is accumulated in the database 14.

The information of the fuel consumption for each vehicle is associated with the road and is stored in the database 14. Herein, the calculation of the fuel consumption is described. The information received from the information terminal 1 includes the position information, the information of the total travel distance, and the information of the remaining fuel. A distance between two points which is a difference between a total travel distance in one point on a road and a total travel distance in another point on the road can be acquired based on the position information and the information of the total travel distance. A difference of a remaining fuel between the above two points can be acquired as an amount of fuel consumed between the two points based on the position information and the information of the remaining fuel. Then, the fuel consumption can be acquired based on the distance between the two points and the amount of fuel consumed between the two points. The fuel consumption maybe calculated by the driving support apparatus 12 as described, and may also be calculated by the information terminal 1.

In step S33, the recommendation driving method calculating unit 15 calculates the recommendation driving method on the road along which the vehicle travels based on the information accumulated in the database 14. The recommendation driving method calculating unit 15 outputs the information regarding the calculated recommendation driving method to the communication unit 13. At this time, the information regarding the recommendation driving method being output to the communication unit 13 includes information necessary for achieving the recommendation driving method (for example, the speed information, the operation information of the brake, the operation information of the accelerator, and the operation information of the handle).

Specifically, the recommendation driving method calculating unit 15 extracts the information of the fuel consumption of a plurality of vehicles which have conditions (for example, a type of vehicle, a season, and an environment) close to the vehicle on the road along which the vehicle travels, and selects the driving method having the best fuel efficiency from the information. As described above, the recommendation driving method calculating unit 15 calculates the driving method having the best fuel efficiency as the recommendation driving method based on the condition of the vehicle on the road along which the vehicle travels.

The recommendation driving method calculating unit 15 calculates, based on the information regarding the component of the vehicle accumulated in the database 14, the driving method of enhancing the endurance of the component as the recommendation driving method. For example, when the database 14 accumulates the information regarding components of vehicles A, B, and C, which are the same type of vehicle, and a component of the vehicle C is most durable, the recommendation driving method calculating unit 15 determines that the driving method of the vehicle C enhances the endurance of the component.

In Step S34, the communication unit 13 transmits the information regarding the recommendation driving method calculated by the recommendation driving method calculating unit 15 to the information terminal 1.

FIG. 8 is a flow chart illustrating an example of the operation of the driving support apparatus 12, and particularly illustrates an operation of the machine learning unit 16.

In Step S41, the machine learning unit 16 makes a choice of the information used for calculating the recommendation driving method in the recommendation driving method calculating unit 15 based on the information accumulated in the database 14. The information used for calculating the recommendation driving method corresponds to the information regarding the condition and component of the vehicle described in Step S33 in FIG. 7 described above.

For example, in a case where the information of the total lighting time of the head light and brightness is not considered to have a relationship with the fuel efficiency and therefore is not used for calculating the recommendation driving method, when a vehicle, which turns on the head light to perform an automatic driving of adjusting a distance from a vehicle which travels ahead, appears afterward, the information of the total light time of the head light and brightness may have influence on the fuel efficiency. In this manner, the relationship of the fuel efficiency or the endurance of the component with the information which has not been used for calculating the recommendation driving method at first is reviewed, thus the recommendation driving method can be improved. In the meanwhile, it may be found, after regularly reviewing the relationship with the fuel efficiency or the endurance of the component, that the information which has been used for calculating the recommendation driving method at first has no relationship with the fuel efficiency or the endurance of the component. In the above case, the information which has been used for calculating the recommendation driving method at first is not used for calculating the recommendation driving method, thus, the recommendation driving method can be improved.

The machine learning unit 16 reviews the information accumulated in the database 14 as described above to make a choice of the information used when the recommendation driving method calculating unit 15 calculates the recommendation driving method. The machine learning unit 16 may review the information at a fixed time interval, or may also review the information at a time of receiving a new information from the information terminal 1.

In Step S42, the machine learning unit 16 provides the recommendation driving method calculating unit 15 with a notice of the information used for calculating the recommendation driving method. The recommendation driving method calculating unit 15 calculates the recommendation driving method based on the information provided by the machine learning unit 16.

FIG. 9 is a flow chart illustrating an example of the operation of the automatic driving device 17.

In Step S51, the communication unit 18 receives the information regarding the recommendation driving method from the information terminal 1.

In Step S52, the automatic driving controller 19 controls the automatic driving of the vehicle based on the received information regarding the recommendation driving method. Specifically, the automatic driving controller 19 controls a speed of the vehicle, an operation of the brake, an operation of the accelerator, and an operation of a handle, for example, to achieve the recommendation driving method. The automatic driving controller 19 receives the information of the route calculated by the navigation unit 6 from the information terminal 1. Accordingly, the automatic driving controller 19 controls the automatic driving so that the vehicles travels along the route received from the information terminal 1.

As described above, the present embodiment enables the appropriate driving support. Specifically, the automatic driving based on the driving method of enhancing the fuel efficiency or the driving method of enhancing the endurance of the component can be performed.

The information terminal 1 described above can be applied not only to an in-vehicle navigation device, that is to say, a car navigation device but also to a Portable Navigation Device (PND) which can be mounted on the vehicle and a mobile communication terminal (for example, a mobile phone, a smartphone, and a tablet terminal). The driving support apparatus 12 functions as a server.

Each function or each constituent element of the information terminal 1 and the driving support apparatus 12 may be dispersedly disposed in the information terminal 1 and the driving support apparatus 12. For example, the information terminal 1 illustrated in FIG. 1 may include the recommendation driving method calculating unit 15 and the machine learning unit 16 of the driving support apparatus 12 illustrated in FIG. 3. The information terminal 1 and the automatic driving device 17 may be integrally formed.

Even the above configuration can also obtain the effect similar to that of the embodiment described above.

A software for executing the operation in the embodiment described above (a driving support method) may be incorporated into a server or a mobile communication terminal, for example.

Specifically, as an example, the driving support method described above (a) acquiring information including an environmental information which is information indicating an environment of a road in a case where each of a plurality of vehicles travels, a travel information which is information regarding the traveling of each vehicle, and a vehicle information which is information regarding each vehicle, (b) accumulating the acquired information, (c) calculating a recommendation driving method which is a driving method recommended at a time of traveling along the road based on the accumulated information, and (d) providing the vehicle which is capable of perform an automatic driving in the plurality of vehicles with a notice of the calculated recommendation driving method.

As described above, the software for executing the operation in the above embodiment is incorporated into the server or the mobile communication terminal and operated, thus the effect similar to that of the embodiment described above can be acquired.

The controller 9 may calculate the information of the more accurate current position of the vehicle based on the information of the current position acquired by the position information acquiring unit 2, the vehicle speed information which the vehicle information acquiring unit 4 acquires from a vehicle speed sensor, and an angular speed information of the vehicle which the vehicle information acquiring unit 4 acquires from a gyro sensor.

The information terminal 1 may perform the operation illustrated in FIG. 5 even when the vehicle does not perform the automatic driving.

As for the information regarding the recommendation driving method transmitted from the driving support apparatus 12 to the information terminal 1, the user may select, via the input unit 7, the driving method of enhancing the fuel efficiency or the driving method of enhancing the endurance of the component as the recommendation driving method.

The driving support apparatus 12 may provide a dealer or a component manufacturer with a notice of a component whose replacement time is determined to be approaching based on the information regarding the component accumulated in the database 14. In the above case, the dealer or the component manufacturer can prepare for a component to be replaced, thus a stock of the component can be easily adjusted.

According to the present invention, each embodiment can be appropriately varied or omitted within the scope of the invention.

The present invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

1 information terminal, 2 position information acquiring unit, 3 environmental information acquiring unit, 4 vehicle information acquiring unit, 5 map information acquiring unit, 6 navigation unit, 7 input unit, 8 communication unit, 9 controller, 10 processor, 11 memory, 12 driving support apparatus, 13 communication unit, 14 database, 15 recommendation driving method calculating unit, 16 machine learning unit, 17 automatic driving device, 18 communication unit, 19 automatic driving controller

1. A driving support apparatus, comprising:
a processor to execute a program; and
a memory to store the program which, when executed by the processor, performs processes of,
acquiring unit acquiring information including an environmental information which is information indicating an environment of a road in a case where each of a plurality of vehicles travels, a travel information which is information regarding a traveling of each of said vehicles, and a vehicle information which is information regarding each of said vehicles,
accumulating unit accumulating said acquired information,
calculating unit calculating a recommendation driving method which is a driving method recommended at a time of traveling along said road based on said accumulated information, and
providing said vehicle which is capable of performing an automatic driving in said plurality of vehicles with a notice of said calculated recommendation driving method.

2. The driving support apparatus according to claim 1, wherein
said environmental information includes at least one of a weather information which is information indicating weather when said vehicle travels along said road and a road surface information which is information indicating a state of a road surface of said road.

3. The driving support apparatus according to claim 1, wherein
said travel information includes a position information of said vehicle.

4. The driving support apparatus according to claim 1, wherein
said vehicle information includes a speed information of said vehicle, an operation information of a handle, an operation information of an accelerator, an operation information of a brake, information of a remaining fuel, and information regarding a component provided in said vehicle.

5. The driving support apparatus according to claim 1, wherein
said recommendation driving method is a driving method of enhancing a fuel efficiency or a driving method of enhancing endurance of a component provided in said vehicle.

6. The driving support apparatus according to claim 1, wherein
said processor further performs a process of making a choice, using a mechanical learning, of said information used for a calculation of said recommendation driving method.

7. A driving support method, comprising:
(a) acquiring information including an environmental information which is information indicating an environment of a road in a case where each of a plurality of vehicles travels, a travel information which is information regarding a traveling of each of said vehicles, and a vehicle information which is information regarding each of said vehicles;
(b) accumulating said acquired information;
(c) calculating a recommendation driving method which is a driving method recommended at a time of traveling along said road based on said accumulated information; and
(d) providing said vehicle which is capable of performing an automatic driving in said plurality of vehicles with a notice of said calculated driving method.
